(19) United States
(12) Patent Application Publication
(10) Pub. No.: US 2007/0148310 A1
(43) Pub. Date: Jun. 28, 2007

(54) Method for treating of oils and fats

(76) Inventor: Seishiro Murakami, Kumamoto (JP)

Correspondence Address: FLYNN THIEL BOUTELL & TANIS, P.C., 2026 RAMBLING ROAD, KALAMAZOO, MI, 49008-1631, US

(21) Appl. No.: 10/584,160

(22) PCT Filed: Dec. 21, 2004
(86) PCT No.: PCT/JP04/19678

§ 371 Date: Jun. 22, 2006

(30) Foreign Application Priority Data
Dec. 25, 2003 (JP) 2003-429573

(51) Int. Cl. A23D 9/00

(52) U.S. Cl. 426/601

(57) ABSTRACT

A method for treatment of oils and fats of high saturated fatty acid content whose treatment has been difficult, especially waste oils and fats and discharged oils and fats, characterized in that the oils and fats just prior to hydrolysis is subjected to ozone treatment and light irradiation treatment.

### FIELD OF THE INVENTION

The present invention relates to a method for treatment of oils and fats, in particular, relates to a method for treatment of oils and fats characterized by making it possible to reuse a treated wasted oils and fats or a treated discharged oils and fats not depending on containing ratio of saturated fatty acid unsaturated fatty acid.

### DESCRIPTION OF THE PRIOR ART

Presently, there are many sorts of wasted oils and fats in Japan. For example, tallow, bovine born oil, internal organ oil of bovine, lard, pig bone oil, internal organ oil of pig, chicken oils and fats, residue oil formed at a refining process of animal oils and fats or vegetable oils and fats, animal foots oil or vegetable foots oil formed at rendering of animal oils and fats or vegetable oils and fats, strong alkaline dark oil formed at a treating process of a foots oil, various wasted animal oils and fats or vegetable oils and fats discharged from a foods processing factory, waste oils and fats discharged from producing process of purified oil for foods as a by-product, for example, discharged oil generally called as “oil foots” at a producing process of beans oil, rapeseed oil or corn oil or waste foods oil such as waste oil from deep-fried food processing. Now a days, it is said that the total amount of these waste oil of a year is more than 10 million tons or more than 20 million tons.

Further, from a disturbance of mad cow disease, it became necessary to treat and burn up bovine originated oils and fats separately from other oils and fats. However, since calorie of bovine originated oils and fats is high, durability of a burning furnace becomes problem, and safe burning up of it can not be expected. Therefore, it is obligated to preserve waste bovine originated oils and fats separately until a treating method is developed, however, actually, bovine originated oils and fats is mixed with other oils and fats and is not controlled as obligated. Therefore, a development of a new treating method is becoming a pressing subject.

Regarding animal oils and fats except bovine originated oils and fats, although a part of it is used as a fodder of a domestic animal, foods or cosmetic composition, mainly is burned up. And, regarding residue oil formed at refining process of animal oils and fats or vegetable oils and fats for foods, since said residue oil is mainly a strong alkaline waste oils and fats, durability of an ordinary furnace is a problem and accordingly a treatment by burning up is impossible.

A part of waste foods oil is used as a fuel of Diesel engine by converting by “methylesterfication method”. This method can be illustrated as follows. That is, methanol or ethanol and sodium hydroxide are mixed to a waste foods oil with constant stirring, then the mixture is left for standing. Glycerin or others, which are impurities, are absorbed by methanol or ethanol and separated to upper side when staying in standing state. And oil, which is located at lower side, is used as a fuel. However, this method can only be applied for refining of high quality waste foods oil, and cannot be applied for refining of middle quality waste foods oil, low quality foods oil or mud waste foots oil. The reason why can be illustrated as follows. That is, “methylesterfication method” is a technique developed 50 or 60 years ago to convert a virgin oil such as soy bean oil or rapeseed oil to a fuel, and can not be applied to an used waste foods oil which is characterized that oxidation degree is progressed to higher level. Therefore, middle quality waste foods oil, low quality foods oil or mud waste foots oil are omitted from the object of refining by this method. Further, oils and fats of high containing ratio of saturated fatty acid is out of the discussion. Furthermore, a method of “conversion of waste foods oil, fish oil to Diesel engine fuel by ozone treatment, is also applied. This method is a technique objected to oils and fats whose containing ratio of saturated fatty acid is high (for example, soy beans oil, rape seed oil, corn oil, camellia oil or fish oil).

Said method is a technique to pour materials to be treated (oils and fats characterized that contents of unsaturated fatty acid is high) into a reaction tank and ozone is added from lower position of the reaction tank, then a double bond of unsaturated fatty acid is dissociated by oxidization forth of ozone, and thus converts the material to a fuel. Therefore, waste oil whose contents of unsaturated fatty acid is high (high quality, middle quality, low quality and mud oil) can be refined by this method, however, oils and fats whose melting point is high and concentration of saturated fatty acid is high, such as palm oil, residue oil of palm oil, coconut oil or residue oil of coconut oil can not be treated by this method. Further, said method can not be applied to strong alkaline waste oil too. For example, in a case when oils and fats whose contents of saturated fatty acid is high is treated by this method, large amount of ozone is added to dissociate double bonds of fatty acid. And when adding amount of ozone become large and time to add becomes long, consequently, saturated fatty acid causes polymerizing reaction by ozone reaction. Said polymerizing reaction means the state that oils and fats causes caking.

Oils and fats can be roughly classified to a saturated fatty acid and unsaturated fatty acid. When content of saturated fatty acid becomes large, melting point and caking ratio become high and solidified quickly. As oils and fats whose content of saturated fatty acid is larger than 80%, tallow (Fedd oil), bovine born oil, pig oil (lard), pig bone oil, chicken oil, sheep oil, goat oil or horse oil can be mentioned. And as a vegetable oil, palm oil, residue oil of palm oil, coconut oil and residue oil of coconut oil can be mentioned.

As oils and fats which contains more than 80% of unsaturated fatty acid, soy beans oil, rape seed oil, sunflower oil or corn oil can be mentioned as a vegetable oil, and fish oil can be mentioned as an animal oil.

Because unsaturated fatty acid can be more easily treated than fatty acid, the development has been progressed on oils and fats whose content of unsaturated fatty acid is high.

### SUMMARY OF THE INVENTION

The present invention relates to a treating method of oils and fats and the object of the present invention is to provide a material for various oils and fats such as fuel by treating oils and fats whose contents of saturated fatty acid is high.

The gist of the present invention is a treating method of oils and fats characterizing to carry out ozone treatment and light irradiation treatment on oils and fats of a state of just prior hydrolysis.

### BRIEF DESCRIPTION OF THE DRAWINGS

FIG. 1 is a flow sheet illustrating processes of the present invention,

FIGS. 2 and 3 are illustrating views of a treatment apparatus of the present invention.

FIG. 4 is an illustration view of a light irradiation apparatus of the present invention,

FIG. 5 is an illustration view of another example of treatment apparatus of the present invention. Marks in drawing are illustrated as follows.

1. Material tank, 2. First pre-treatment tank,
3. Second pre-treatment tank, 4. Pre-filtration filter press,
5. Pre-coating tank, 6. Oil separator, 7. Special ray irradiation device,
8. First treating tank, 9. Cooling chiller, 10. Second filtration device,
11. Pre-coating tank, 12. Second treating tank,
13. Third filtration device, 14. Pre-coating tank, 15. Regulating tank,
16. Cartridge tank, 17. Vapor generating device,
18. Ozone generating device, 19. Ozone inserting opening,
20. Material gas pipe,
21. First tank (liquidizing tank), 22. Second tank (liquid recovering tank),
23. Filtration device, 24. Liquefied gas fuel tank, 25. Stirrer
26. Filter, 27. Lubricating oil recovering device

### DESCRIPTION OF THE PREFERRED EMBODIMENT

The present invention will be illustrated more in detail.

Regarding waste oils and fats and discharged oils and fats which can be treated by the present invention, it is possible to be treated not considering a containing ratio of saturated fatty acid-unsaturated fatty acid. Waste oils and fats of the present invention means oils and fats which is treated by alkali or refined during rendering process, however, also not treated oils and fats can be treated. Specifically, animal oil such as tallow (Fedd oil), bovine bone oil, pig oil (lard), pig bone oil, chicken oil, sheep oil, goat oil, horse oil or fish oil or vegetable oil such as palm oil, residue oil of palm oil, coconut oil and residue oil of coconut oil, soy beans oil, rape seed oil, sunflower oil or corn oil can be mentioned.

Further, regarding an ozone treatment, since double bond or triple bond of saturated fatty acid or unsaturated fatty acid becomes easy to dissociate by light, ozone is inserted from lower part of each treating reaction tank, and specific treatment is performed on an ozone inserting opening so as to progress ozone reaction smoothly. Said specific treatment means that a metallic net having 0.5 μm to 1 μm openings is equipped in a pipe of ozone inserting opening. By equipping said fine metallic net, ozone is divided to ultra fine bubbles and reaction can be progressed smoothly.

These waste oils and fats or discharged oils and fats (shortened to simply oils) should be set to a state of just prior hydrolysis. For the purpose to set to a state of just prior hydrolysis, it is necessary to add moisture (vapor) to the oils and to carry out heat treatment and is desirable to press by 3-10 atoms aiming to shorten treating time. By setting to a state of just prior hydrolysis, stable saturated fatty acid becomes to easier reactionable state by light irradiation and by ozone treatment.

Ozone treatment and light irradiation treatment are carried out on the oils set to a state of just prior hydrolysis. Either ozone treatment or light irradiation treatment can be carried out first. Regarding light irradiation treatment, it is desirable to change the wave-length of light to be irradiated according to a sort of the oils, for example, in a case to produce Diesel engine fuel from tallow, desirable wave-length of light is 155 nm to 325 nm which belongs to domain of ultra violet, further, according to power of a ray generating source, light of 185 nm to 256 nm can be used. Furthermore, in a case to produce an oil which does not solidify at approximately 0° C., which is used in foods processing or cosmetic composition processing, it is possible to cause a cleavage reaction and to produce an oil which does not solidify at approximately 0° C. by combining ultra violet light, visible light and infra red light of 356 nm-405 nm-800 nm.

### EXAMPLE

### Example 1

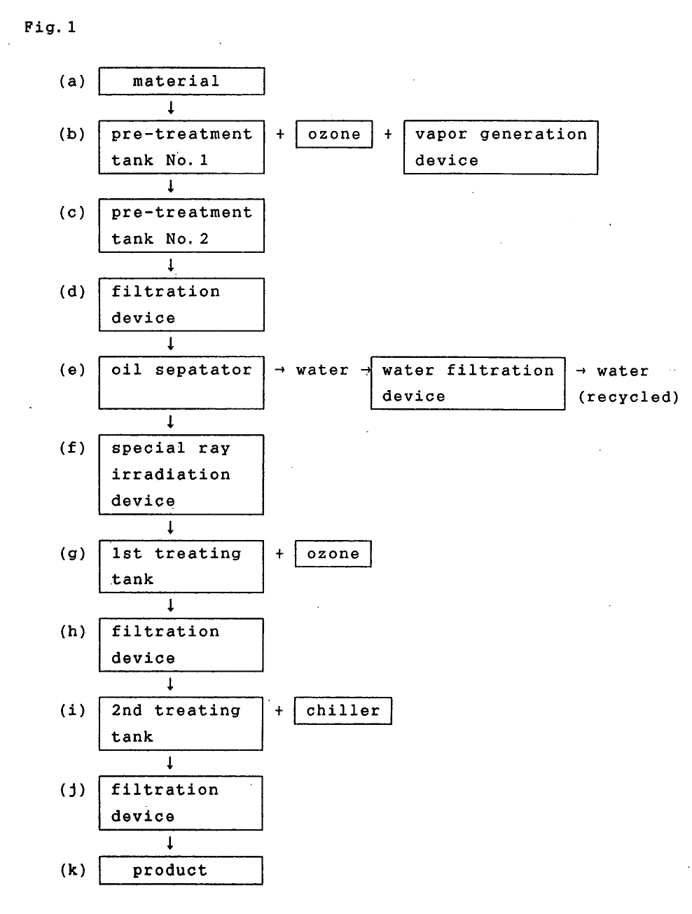

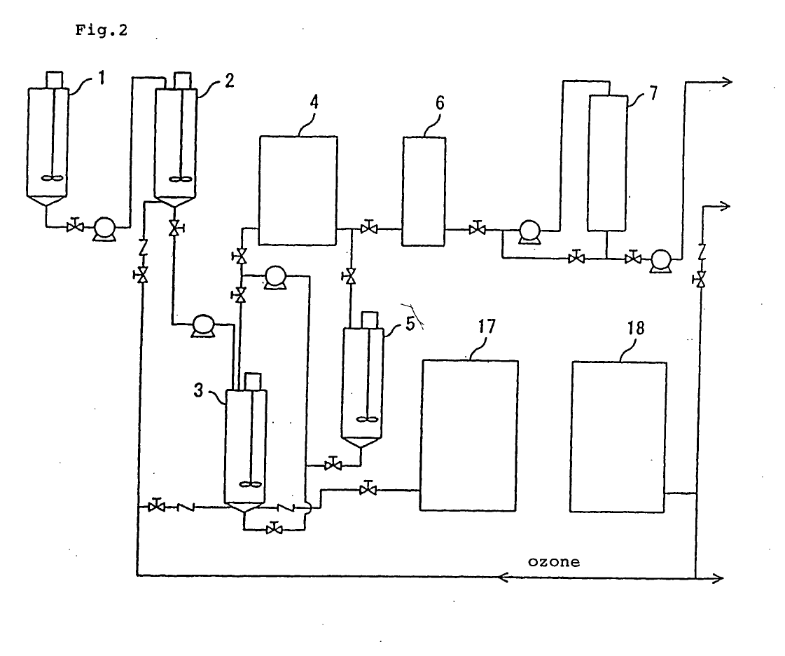

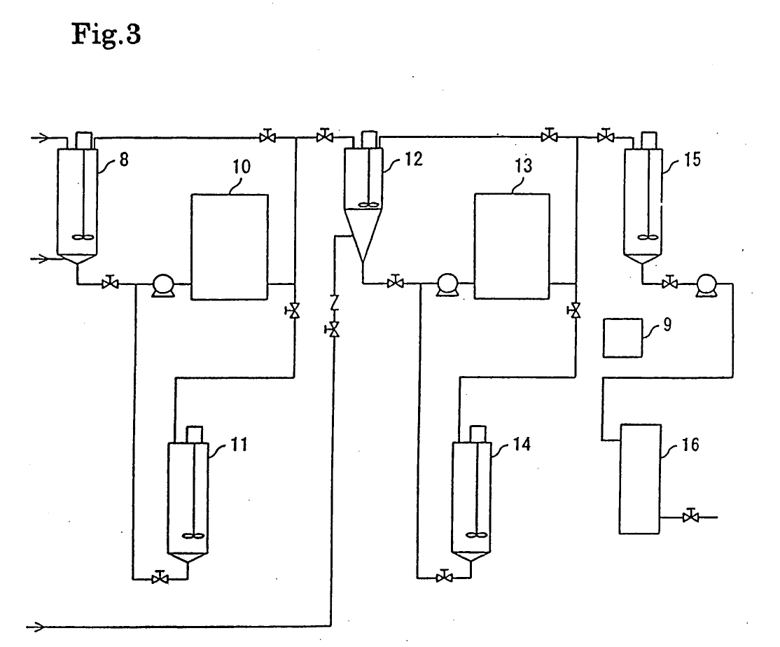

As an Example of the present invention, a flow sheet of FIG. 1 which relates to a process to produce Diesel engine fuel from tallow will be illustrated. FIGS. 2 and 3 illustrate an equipment of the present invention, however, is not intending to restrict the scope of claims of the present invention.
(a) Material is supplied to a material tank (1) of approximately 20L capacity. Various sorts can be mentioned as a material, and the material is heated in the material tank according to the purpose of treatment. Material is regulated by adding 3-5% of water to the total amount of the material if necessary.
(b) The regulated oil is transferred to a first pre-treatment tank (2). The first pre-treatment tank (2) has a capacity of approximately 20L which is same volume to the material tank. Since the purpose is to produce Diesel engine fuel from tallow, 3-8% of vapor to the total amount of the material is blown from the lower part of the tank so as to program the temperature to 120° C.-130° C., and ozone, which is generated from an ozone generating device (18), is introduced from the lower part of the tank. This pre-treatment reacting apparatus is pressed by 1-2 atoms and stirred well. The material is reacted to a state of just prior hydrolysis. For the purpose to shorten the treating time, it is possible to press the apparatus to 3-10 atoms. Further, this reacting apparatus is heated to 150° C.-250° C. and 5-8% or 10% of vapor to the total amount of the material is added and ozone is introduced. After this process, said reacting apparatus is vacuumed to minus 2-3 or 5 atoms and vapor (water) used in previous process is removed. Thus the material is reacted to a state of just prior hydrolysis.
(c) Then the material which is in a state of just prior hydrolysis in the first pre-treatment tank is poured into a second pre-treatment tank (3). To the material poured into the second pre-treatment tank (3), a stirrer which can pulverize the material to ultra fine particles and stir it by rotating speed of 300-400 r.p.m. The stirrer which can pulverize the material to ultra fine particles of the present invention is characterized that a stainless steel wire blush is equipped at a pointed end of the stirrer or using a propeller processed to have sawteeth shape.

By a heater equipped to the equipment of the present invention, humid (vapor) which can not be removed by a vacuum process is removed by heating. Said heating is carried out at the temperature of 95° C.-100° C. or 100° C.-120° C. Impurity is extracted from the material oil which is staying in a state of just prior hydrolysis. For the purpose to remove impurities, the material oil is passed through a first filtration device. And, during said process, ozone is added from the lower part of the equipment. During the process to add ozone and to promote oxidization, for the purpose to oppress the excess oxidization, 1-2% of sawdust or woody tips to the total amount of the material are added.
(d) First filtration device: Material which passed the second pre-treatment process is passed through the first filtration device for the purpose to remove impurity extracted in the second pre-treatment process such as glycerin or absorbing agent added at the process such as woody tips added at the process are removed. The first filtration device is consisting of a pre-filtration filter press (4), a filtering cloth of the pre-filtration filter press (4) is coated with an absorbing agent such as activated clay, diatomaceous earth, zeolite or activated carbon. Accordingly, impurities formed at the second pre-treatment device is absorbed and removed. The amount of the absorbing agent is 1-3% to the total amount of the material or according to a sort of material 2-6% to the total amount of the material.
(e) Oil separator: The purpose of an oil separator is to remove humid more perfectly remaining at the previous vacuum dehydration process. That is, material contained in the second pre-treatment device is filtrated by the first filtration device and flown to the oil separator (6). The oil separator is aiming to remove emulsified water remaining in the second pre-treatment device. Said emulsified water is originated from humid (vapor) that is used in the material tank and in the first pre-treatment device and is not removed by the second pre-treatment device.

Shape of the oil separator is cylindrical. Material is poured into the cylinder and discharged to the outside of the cylinder. This cylinder is specifically processed. Namely, diameter of holes to pass through is becoming larger from inner side toward outer side. Diameter of hole of the innermost side is 1 μm and the diameter of hole of the outermost side is from 20 μm to 30 μm, and by enlarging the size of fine particles (clusters) of emulsified material (oil-water), oil and water is instantly separated when discharged to the outside of the cylinder.

Separated oil is progressed to the next process. And separated water is transferred to a vapor generating device for the purpose to reuse after filtrated by activated carbon.
(f) Special ray irradiation device: Material (oil) after water is separated is flown into a special ray irradiation device (7). In a case to produce Diesel engine fuel from tallow, wavelength of light to be used in the present invention is wavelength of ultra violet domain of 155 nm-325 nm, further, according to the power of a ray generating source, light of 185 nm to 256 nm can be used. In a case to use oils and fats whose containing ratio of saturated fatty acid is high to the use excepting fuel, for example, to produce an oil not solidifying at approximately 0° C., which is used in foods processing or cosmetic compounds processing, it is possible to cause a cleavage reaction and to produce said oil which does not solidify at approximately 0° C. by combining ultra violet light, visible light and infra red light of 356 nm-405 nm-800 nm.

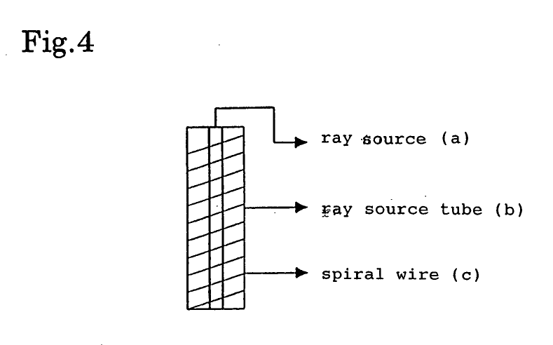

As a method for irradiation, a spiral wire of glass or silicone is wound around a ray source tube, and the material is flown along with the spiral wire from upper side to lower side so as to irradiate light. One example is shown in FIG.4.

As the other method for irradiation, a method to irradiate by spraying the material in state of mist or fog, a dipping method, or a wet wall method can be used. Namely, it is important to expand the irradiation area.

From next step, process is illustrated according to FIG.3.
(g) First treating apparatus: In the case of fuel producing, the material after the process by a special ray irradiation device (7) indicates igniting feature at this stage. And in the case of oils excepting fuel, the material after said process becomes not to solidify at approximately 0° C. In the case of fuel producing, the purpose of the first treating tank (8) is to improve the quality as fuel, and in the case of oils excepting fuel, the purpose of the treatment is to enhance the value. To the transported material, 1-2% of rice-bran to the total amount of the material is added. Oil washing process by rice-bran is carried out and simultaneously ozone is inserted through an ozone inserting opening so as to carry out ozone reaction. (18) is an ozone generating device.
(h) Second filtration device: Inside of the second filtration device (10) is coated by one cake layer selected from the group consisting of activated clay, diatomaceous earth, zeolite or activated carbon which is transported from a pre-coating tank (11). By this cake layer, rice-bran added during the first treating process by 1-2% to the total amount of the material is removed and the quality of oils is improved.
(i) Second treating apparatus: Material after passed through the second filtration device (10) is transferred to a second treating tank (12). Object of this tank is to improve the oils containing high amount of saturated fatty acid whose melting point is high such as animal oil, palm oil or vegetable oil not to solidify at the temperature lower than 0° C. Material is cooled down by a cooling chiller equipped to the inside of the tank according to the purpose. Chilling temperature and the effect by chilling are as follows.

Material which passed through each refining process is transported to a second treating tank and a second filtering device. When the material treated in the second treating tank is cooled down to 5° C. by a cooling chiller, then passed through the second filtering device, the filtrated material does not solidify at the temperature of from −7° C. to −15° C. in a refrigerator.
Material is cooled down to 10° C. →does not solidify up to −5° C. to −7° C.
Material is cooled down to 5° C. →does not solidify up to −7° C. to −15° C.
Material is cooled down from 0° C. to 1° C.→does not solidify up to −20° C. to −30° C.
(j) Third filtration device: Inside of a third filtration device (13) is coated by one cake layer selected from the group consisting of activated clay, diatomaceous earth, zeolite or activated carbon which is transported from a pre-coating tank (14). Material after treated by the second treating apparatus (12) is passed through a cake layer of the third filtering device (13) and filtrated and introduced to an regulating tank (15). Then the material is passed through a cartridge tank and an aimed product is produced.

Physical properties of the product obtained by conversion of tallow (Fedd oil) to Diesel engine fuel is summarized in Table 1 in comparison with a methylesterfication method and light oil on the market.

TABLE 1

| | Tallow | Methylesterfication | |
|---|---|---|---|
| | after treated | method | Light oil |
| Calorific value | 10.733 | 9500 | 10920 |
| Cal/kg | | | |
| Density (15° C.) | 0.888 | 0.888-0.90 | 0.835 |
| g/cm³ | | | |
| Dynamic viscosity | 8 | 8-9 | 5-6 |
| mm²/S | | | |
| Flashpoint ° C. | 37 | 130-140 | 66 |
| Fluidizing point ° C. | −7.5 | Max −5 | −8 |
| Sulfur contents % | 0.0016 | 0.01 | <0.2 |

Pig oil (lard oil) whose solidifying point (freezing point) is +30° C. is refined by above mentioned apparatus, and as a result, liquid oil whose freezing point is −5° C. is obtained.

### Example 2

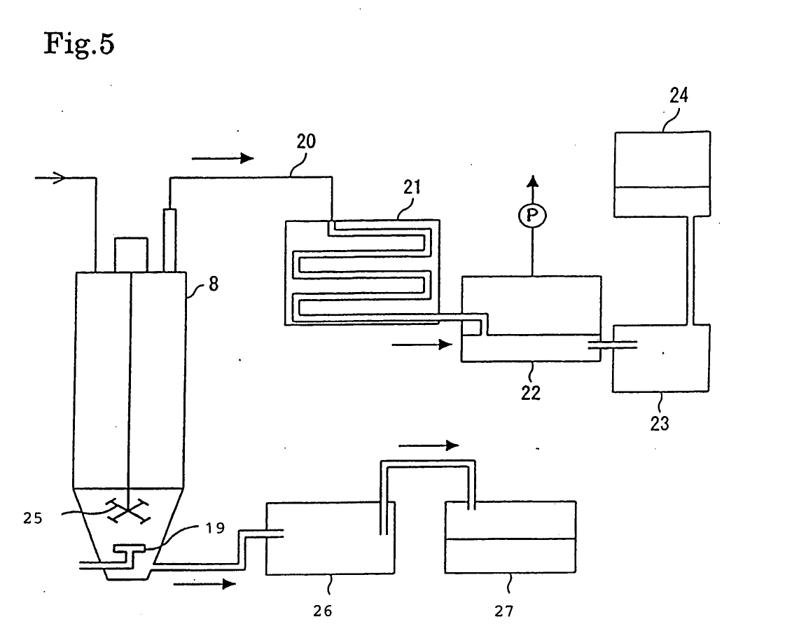

In this Example, a method to obtain lubricating oil or fuel to be used instead of gasoline will be illustrated based on FIG.5.

Same as to Example 1, according to the process shown in FIG. 2, (f) material after light irradiation treatment by a special ray irradiation device is transported to a first treating device (8). (in FIG. 2, as far as a special ray irradiation device (7) is a same apparatus.)
1) Material after ray irradiation treatment is transferred to a first treating tank (8). After transferred, 3-10% of a gas inducing agent to the total amount of the material is added to the material and stirred well. Rotating speed of a stir is approximately 300 r.p.m. As a gas inducing agent, hexane etc can be used.

As the result of light irradiation, hydro carbon oil is formed by 20-30% ratio in the transferred material.

To the inside of the first treating apparatus, specially processed ozone inserting opening (19) is equipped, and from this opening fine bubbles of ozone of 0.1 μm-05 μm size are blown in strongly and the blown in ozone emulsify the material instantly. From the emulsified material, gas of hydro carbons is formed. The formed gas is transferred to a gas recovering apparatus mentioned below and liquefied. The liquefied product is almost same as to gasoline of high octane value. Recovering ratio from material is 40-50%, and 50-60% of residue is lubricating oil.

Gas Recovering Apparatus

The gas recovering apparatus is composed of first tank (21), second tank (22) and a filtration device (23). First tank liquidates gas discharged from the first treating apparatus through a pipe (20) and second tank acts as a recovering part of liquefied liquid. Functions can be illustrated as follows.
(a) Gas discharged from the pipe (20) is introduced into spiral pipe formed in inside of the first tank (21).
(b) A proper quantity of water is contained in the first tank (21), said water is kept at 0° C. and by quenching, the gas is liquefied.
(c) Aiming smooth liquidation of gas, a vacuum pump is equipped to second tank (22) (recovering part) and operate the vacuum pump to improve recovering effect.

For the purpose to improve the quality, the recovered liquid is filtrated by a filtration device (23). As a method for filtration, filtration by a filter press, vacuum filtration or spontaneous filtration can be mentioned. As a filter, activated carbon, activated clay or zeolite can be used. The filtrated liquefied gas fuel is preserved in a liquefied gas fuel tank (24).

Material remaining in the first treating apparatus causes polymerization reaction by effect of fine particles of ozone regulated to 2-5 μm size discharged from an ozone inserting opening (19) equipped to the lower part of apparatus. Expecting more rapidly and accurately cause the polymerization reaction, stirring is carried out. Desirable rotating speed is 10000-30000 r.p.m. However, if a stir to the end of a rotating axis of which a special processed stirrer (25) is equipped, rotating speed can be 300-360 r.p.m.

As a stirrer (25), is not restricted, however, when a stirrer characterizing a wire blush of 0.1-0.3 mm size is equipped at a pointed end of the rotating axis forming cross shape or a stirrer using a propeller processed to have sawteeth shape is used, remarkable effect can be obtained.

Filtration process is set for the purpose to improve the quality of polymerized material. Filtrating operation is carried out same as to above mentioned gas recovering process. That is, a filtering device (26) can be filter press, vacuum filtration or spontaneous filtration and as a filter, activated carbon, activated clay or zeolite can be used. Polymerized material after filtration process is recovered at a lubricating oil recovering device (27).

From this treated material, a lubricating oil of hardness 10 w-30w˜10w-40 for gasoline engine or for Diesel engine can be produced.

### APPLICABILITY FOR INDUSTRIAL USE

By the treating method of the present invention, oils and fats whose content of saturated fatty acid, which is recognized to be hard to refine, can be refined by a simple refining method and can be provided as a material for various oils and fats. That is, this method is suited to a treating method of oils and fats whose content of stable saturated fatty acid, waste oils and fats or, in particular, waste oils and fats originated to mad cow disease, and is useful to produce Diesel engine fuel, lubricating oil or fuel can be used instead of gasoline

1. A method for treating of oils and fats comprising, to carry out an ozone treatment and a light irradiation treatment on oils and fats of a state just prior hydrolysis.

2. A method for treating of oils and fats comprising, adding vapor to oils and fats at atmospheric pressure or at pressure condition lower than 10 atoms, emulsifying said oils and fats by discharging fine bubble state of ozone having 0.05-0.1 μm size, further carrying out a light irradiation treatment.

3. The method for treating of oils and fats of claim 1, wherein oils and fats is waste oils and fats or discharged oils and fats.

4. The method for treating of oils and fats of claim 1, wherein oils and fats is animal oils and fats such as tallow, bovine born oil, pig oil, pig bone oil, chicken oil, sheep oil, goat oil or horse oil, vegetable oil such as palm oil, residue oil of palm oil, coconut oil or residue oil of coconut oil.
